(19) United States
(12) Patent Application Publication
(10) Pub. No.: US 2017/0103585 A1
(43) Pub. Date: Apr. 13, 2017

(54) ViaValet

(71) Applicant: Tovia Hoffman, Lakewood, NJ (US)

(72) Inventor: Tovia Hoffman, Lakewood, NJ (US)

(21) Appl. No.: 15/292,114

(22) Filed: Oct. 12, 2016

Related U.S. Application Data
(60) Provisional application No. 62/240,213, filed on Oct. 12, 2015.

(51) Int. Cl. G07B 15/02

(52) U.S. Cl. CPC G07B 15/02

(57) ABSTRACT

A computer-implemented system for managing a plurality of vehicle parking spaces distributed over a plurality of physically separate parking locations. The system comprises a server including one or more databases tor storing information associated with a vehicle and the user of the vehicle. The server is configured to send the information to a first one or more hand-held devices communicatively linked to said server wherein the first one or more hand-held devices send the received information along with a request to retrieve the vehicle from a location, to a valet computer. The valet computer sends this information to the central server. The central server sends the request to retrieve the vehicle to a second one or more hand-held devices operated by a user instructing said user to retrieve said vehicle from the desired location.

### CROSS REFERENCE TO RELATED APPLICATIONS

This application claims priority to U.S. Provisional Patent Application No. 62/240,213 filed on Oct. 12, 2015, which is incorporated herein in its entirety by reference.

### FIELD

This disclosure relates to valet parking services and more particularly, to a system and corresponding method for providing valet parking services.

### BACKGROUND

Valet services traditionally issue paper tickets, each having three detachable sections with a serial number printed, on each section. When a guest drops off his car, the valet parking employee gives a first section to the guest, who retains this section for presentation to the valet parking employee upon returning to pick up his car. After parking the car, the employee places a second section of the ticket in the car, typically hung from the rearview mirror, to identify the car when being retrieved. The employee attaches a third section of the ticket to the car keys that the guest leaves with the employee upon dropping off the car so that the keys can be identified from others in the valet key bin. When the guest returns to pick up his car, the guest presents the first ticket section to the valet parking employee. The employee matches the serial number on the first ticket section to a ticket section attached to a set of car keys in the valet key bin. The employee then takes those keys and retrieves the car having a matching serial number on the ticket section in the car. At the end of the day, the valet company matches revenue received against the number of tickets utilized. This process usually works well, but problems can and do occur when using paper tickets. For example, the guest may lose his ticket section. The employee may remember the guest and his car, but if not, a lengthy process may ensue to match the guest to his car and properly verify the guest as the owner of the car. Tickets also cost the valet company money and have to be transported in sufficient numbers to each valet parking station.

Another disadvantage with paper tickets is that the guest cannot start the process of reclaiming his car until he arrives at the valet station and hands his ticket section to the valet parking employee. The guest must then wait while the employee finds the keys and retrieves the car from a remote location. With the explosion in mobile phone technology, a few vendors have developed a text-based request process that enables the guest to request his car before returning to the valet station. The valet system basically operates the same, but the guest is also given a phone number to which the guest can text a message consisting of his ticket serial number when he wants the valet parking employee to retrieve his car. The phone number is SIM-card inserted in a printer at the valet station, and when the guest sends the text message, the printer receives the message and prints out the ticket number for the employee. The employee then retrieves the guest's car in the traditional manner. In this way, the car may be waiting at the valet station when the guest physically returns.

Although enabling the guest to request the vehicle without being physically present at the valet station, this system still has a number of disadvantages. No confirmation is given to the guest, so he does not know whether he properly keyed in the phone number and the ticket serial number. If he did not, the valet printer will not receive the message or will print out the mistyped ticket number. In either case, the guest will be disappointed when he arrives at the valet station and his car is not ready for him.

### BRIEF SUMMARY

The primary objective of the present disclosure is to provide a computer-implemented system for providing basic valet parking through centrally-managed parking services.

The inventive aspect described in the specification can be embodied a computer-implemented system for managing a plurality of vehicle parking spaces distributed over a plurality of physically separate parking locations, the system comprising—a server including one or more databases for storing information associated with a vehicle or a user of the vehicle, a first memory and processor, the first memory including a non-transitory computer-readable-medium having computer-executable instructions stored therein that when executed by the first processor, cause the first processor to send the information associated with the vehicle or the user of the vehicle to a first one or more hand-held devices communicatively linked to said server; wherein, the first one or more hand-held devices are configured to: receive the information associated with the vehicle or the user of the vehicle from said server; send, to a computer, a request to retrieve the vehicle from a desired location in said parking space for parking said vehicle, said request including the received information associated with the vehicle of the user of the vehicle, said computer including a second memory and processor the second memory including a non-transitory computer-readable-medium having computer-executable instructions stored therein that, when executed by the second processor, causes the second processor to send the request to retrieve the vehicle to said server; and wherein, said server is further configured to: receive said request to retrieve the vehicle from said computer; and send the request to retrieve the vehicle to a second one or more hand-held devices operated by a user instructing said user to retrieve said vehicle from the desired location.

In an example embodiment, the server is further configured to interface over a plurality of computer network.

In a further example embodiment, said first hand-held devices receive an identifier associated with said vehicle or the user of the vehicle.

In a further example embodiment, said request include short messages.

In a further example embodiment, said short messages comprise of the information related to said vehicle in textual form.

In a further example embodiment, said short messages include payment information.

In a further example embodiment, said payment information is calculated based on included hours of operation.

The summary is provided to introduce example inventive concepts, that are further described below in the detailed description. In this respect, before explaining at least one embodiment of the inventive concept in detail, it is to be understood that the disclosure is not limited in its application to the details of construction and to the arrangements of the components set forth in the following description or illustrated in the drawings. The inventive concept is capable of other embodiments, and of being practiced and carried out in various ways. Also, it is to be understood that the phraseology and terminology employed herein are for the purpose of description, and should not be regarded as limiting. For a better understanding of the inventive aspect, its operating advantages, and the specific embodiments attained by its uses, reference should be made to the accompanying drawings and descriptive matter, in which there are illustrated preferred embodiments of the invention.

### BRIEF DESCRIPTION OF THE DRAWINGS

The example embodiments of the inventive aspect will be better understood from the following brief description taken in conjunction with the accompanying drawings. The FIGS. 1-3B represent non-limiting, example embodiments.

FIG. 1 shows a computer implemented system for providing valet parking through a centrally-managed parking services according to an example embodiment.

FIG. 2 shows various components of the computer implemented system for providing a valet parking through a centrally-managed parking services, according to an example embodiment.

FIG. 3 shows a valet system, according to an example embodiment.

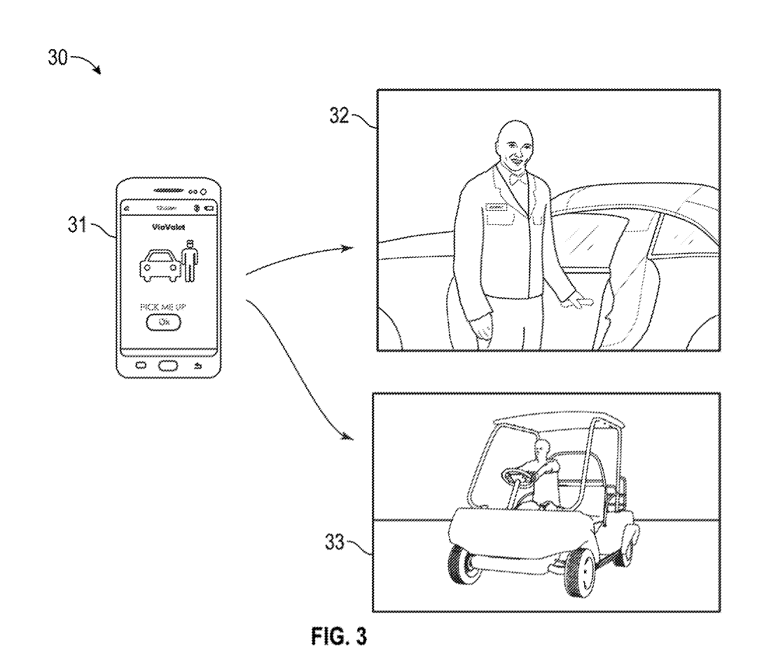

FIG. 4 shows a computer used in the system, according to an example embodiment.

### DETAILED DESCRIPTIONS

The present invention can be implemented on any communication device that has hardware components that can perform wireless and wired communication, such as (but not limited to)—multi-purpose pocket computers, personal multimedia devices, etc.

The various devices on which the applications that implement the present invention run may use one or more processors with different instruction-sets, architectures, clock-speeds, etc. and memory that may include high speed random access memory and may include non-volatile memory, such as one or more magnetic disk storage devices, flash memory devices, and other kinds of solid state memory devices.

The various applications that can implement the present invention run on electronic devices that may use at least one physical user interface device that provide the means of control and navigation within the operating system. Applications that run on the devices include (but are not limited to) touch-pads, such as those described in that not limited to)—(1) U.S. patent application Ser. No. 10/722,948 (“Touch pad for handheld device”, filed Nov. 25, 2003); (2) U.S. patent application Ser. No. 10/188,182 (“Touch pad for handheld device”, filed Mar. 21, 2006); (3) U.S. patent application Ser. No. 08/210,610 (“Computer system with touchpad support in operating system”, filed Mar. 18, 1994); (4) U.S. patent application No. 643,256 (“Movable touch pad with added functionality”, filed Ser. No. 10/643,256), touch screens such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint. Touchscreen,” filed on May 6, 2004; (3) U.S. patent application Ser. No. 10/901,964, “Gestures For Touch Sensitive Input Devices,” filed on Jul. 30, 2004; (4) U.S. patent application Ser. No. 11/048,264, “Gestures For Touch Sensitive input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/36,749, “Multi-Functional Hand-Held Device,” filed on Mar. 3, 2006, click wheels, such as those described in U.S. patent application Ser. No. 11/549,619 “Method, device, and graphical user interface for dialing with a click wheel” filed on Oct. 13, 2006, keyboards, such as those mentioned in(but not limited to U.S. patent application Ser. No. 07/711,760 (“Ergonomic keyboard input device” , filed on Jun. 6, 1991), mouse, such as those described in (but not limited to) (1) application Ser. No. 09/167,314 (“Computer mouse with enhance control button(s)”, filed on Oct. 6, 1998); (2) application Ser. No. 08/288,945 (“Roller mouse for implementing scrolling in windows applications”, filed on Aug. 10, 1994) and gesture recognition means, such as those described in (but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between user and these electronic devices.

Connectivity of these devices with networks, such as the intern an intranet and/or wireless network, such as cellular telephone network, a wired or wireless local area network (LAN) and/or metropolitan area network (MAN) and/or WAN (wide area network) and other wireless communication is achieved by use of a plurality of communication standards, protocols and technologies like Bluetooth, Wireless Fidelity (Wi-Fi) and/or any other suitable communication protocol, including communication protocols not yet developed as of the filing date of this document.

The present invention may be implemented on applications that run on a single or variety of operating system platforms, including but not limited to OS X, WINDOWS, UNIX, IOS, ANDROID, SYMBIAN, LINUX, or embedded operating systems, such as VxWorks.

The present invention may also be implemented to work with various web browsers, including but not limited to Internet Explorer, Mozilla Firefox, Safari, and Opera, that access and handle various types of web pages constructed with various mark-up languages, such as HTML, HTML-5, XHTML, XML, etc. and the associated CSS (cascading style sheet) files and java-script files.

Example embodiments of the inventive concepts may be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a,” “an” and “the” are intended to include the plural forms as well unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The embodiments of the present disclosure relate to a valet system and method of use involving a valet computer having processing power and memory and communicatively linked to one or more hand-held interface devices utilized by valets. The valet computer is configured to communicate with smart phone and/or similar mobile devices possessed by vehicle owner/drivers to transmit at least an electronic virtual valet ticket for display thereon while the one or more hand-held interface devices are configured to receive vehicle owner/driver and vehicle information and transmit the same to the valet computer.

In one embodiment the hand-held interface device of the owner/driver is a smart phone, it receives an identifier assigned to said owner/driver. A request is sent and received in a short message. The centralized server is configured to send and receive the short message to and from the hand-held device. Further the short message comprises of information related to the motor vehicle in textual form. Also the short message comprises of at least one piece of information that includes payment information, calculated on the basis of hours of operation.

In an example embodiment, a computer-implemented system is provided for basic valet parking through centrally-managed parking services. The system comprises a server configured to manage a plurality of motor vehicle parking spaces to park a motor vehicle, distributed over a plurality of physically-separate and openly-disbursed parking locations through a centrally-located server; one or more databases provided at the server for storing vehicle owner/driver and/or vehicle information; one or more hand-held interface devices communicatively linked to the server, the one or more hand-held interface devices for receiving the vehicle owner/driver and/or vehicle information and transmitting the vehicle owner/driver and/or vehicle information to the valet computer. The system is configured to: send, through the one or more hand-held interface devices, to the valet computer a request to retrieve the motor vehicle from a specific location convenient to the owner/driver of the motor vehicle in the parking space for parking the motor vehicle; subsequently receive at the server, a motor vehicle retrieval request; associating the vehicle retrieval request message with the owner/driver information; and sending a retrieval instruction message from the server to the one or more hand-held interface devices operated by a valet employee instructing the valet employee to retrieve the motor vehicle.

According to one embodiment of the disclosure, the server is further configured to interface over a computer network and comprises a memory and a computer processor. The computer processor operatively coupled to the memory and configured to execute computer executable program modules and instructions.

Although specific embodiments have been illustrated and described herein, it will be appreciated by the of ordinary skill in the art that any arrangement that is calculated to achieve the same purpose may be substituted for the specific embodiment shown. This application is intended to cover any adaptations or variations of the present invention.

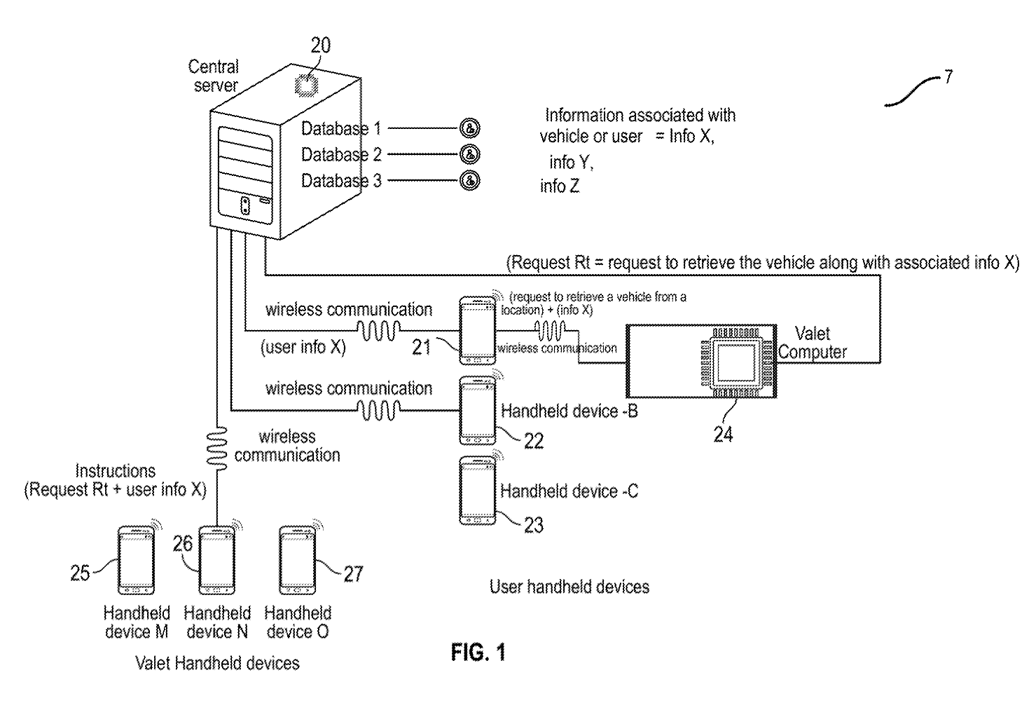

FIG. 1 shows an example embodiment of a computer-implemented system 7 configured to manage a plurality of vehicle parking spaces distributed over a plurality of physically separate parking locations. The system 7 comprises a server 20, a plurality of handheld devices 21-23, 25-27 and a valet computer 24 which exchange data and messages. Central server 20 comprises memory and processor and have one or more databases (Database 1, database 2, and . . . database N) for storing information associated with a vehicle or a user of the vehicle. The memory includes a non-transitory computer-readable-medium having computer-executable instructions stored therein that, when executed by the processor, cause the processor to send the information associated with the vehicle or the user of the vehicle to first one or more hand-held devices 21-23 that are wirelessly linked to said server 20.

The one or more hand-held devices 21-23 are configured to receive the information associated with the vehicle or the user of the vehicle 32 from said server 20. The one or more hand-held devices 21-23 are further configured to send, to a valet computer 24, a request to retrieve the vehicle 32 from a desired location in said parking space for parking said vehicle 32. Such request further includes the information associated with the vehicle or the user of the vehicle 32.

In an example embodiment, said valet computer 24 includes a memory 51 and processor 50, the memory 51 including a non-transitory computer-readable-medium having computer-executable instructions stored therein that, when executed by the second processor, cause the processor of the computer 24, to send the request, to retrieve the vehicle to said server 20 via a wired or wireless means.

The server 20 is further configured to receive said request to retrieve the vehicle from said computer and send the request to retrieve the vehicle to second one or more hand-held devices 25-27 operated by a user instructing said user to retrieve said vehicle from the desired location.

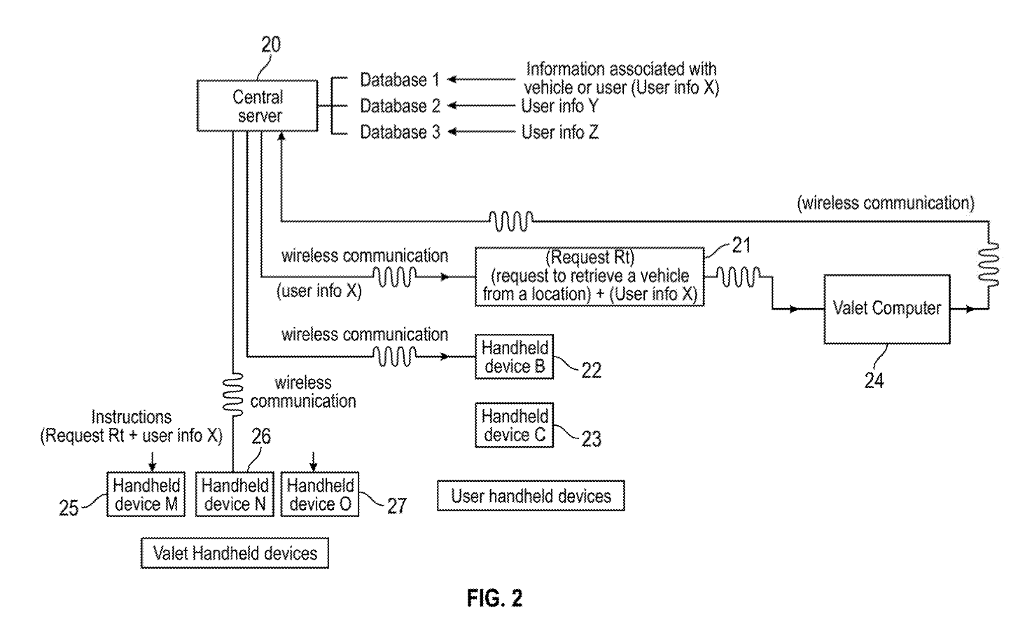

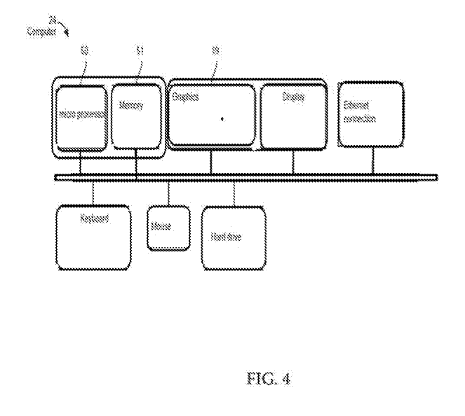

FIG. 2 illustrates communication and data exchange between the components of the system 7 according to an example embodiment. FIG. 4 illustrates computer 24.

In another example embodiment, the first one or more hand-held devices 21-23 are further configured to send, to a valet computer 24, a request to retrieve the vehicle 32 to a desired location in said parking space for parking said vehicle 32. Such request further includes the information associated with the vehicle or the user of the vehicle 31.

Although the inventive concept has been described in relation to its preferred embodiment, it is to be understood that many other possible modifications and variations can be made without departing from the spirit and scope of the inventive aspect.

What is claimed is:

1. A computer-implemented system for managing a plurality of vehicle parking spaces disbursed over a plurality of physically separate parking locations, the system comprising:
a server including one or more databases for storing information associated with a vehicle or a user of the vehicle, a first memory and processor, the first memory including a non-transitory computer-readable-medium having computer-executable instructions stored therein that, when executed by the first processor, cause the first processor to,
send the information associated with the vehicle or the user of the vehicle to a first one or more hand-held devices communicatively linked to said server; wherein
the first one or more hand-held devices are configured to:
receive the information associated with the vehicle or the user of the vehicle from said server;
send to a computer a request to retrieve the vehicle from a desired location in said parking space for parking said vehicle, said request including the received information associated with the vehicle or the user of the vehicle, said computer including a second memory and processor, the second memory including a non-transitory computer-readable-medium having computer-executable instructions stored therein that, when executed by the second processor, cause the second processor to send the request to retrieve the vehicle to said server; and
wherein,
said server is further configured to:
receive said request to retrieve the vehicle from said computer; and
send the request to retrieve the vehicle to a second one or more hand-held devices operated by a user instructing said user to retrieve said vehicle from the desired location.

2. The computer-implemented system as set forth in claim 1, wherein said server is further configured to interface over a plurality of computer network.

3. The computer-implemented system as set forth in claim 1, wherein said first hand-held device receive an identifier assigned to said vehicle or the user of the vehicle.

4. The computer-implemented system as set forth in claim 1, wherein said first hand-held device is a smart phone.

5. The computer-implemented system as set forth in claim 1, wherein said second hand-held device is a smart phone.

6. The computer-implemented system as set forth in claim 1, wherein said request sent from said first or second hand-held device are short messages.

7. The computer-implemented system as set forth in claim 1, wherein said short messages comprises of information related to said vehicle in textual form.

8. The computer-implemented system as set forth in claim 1, wherein said server is configured to send and receive said short messages to and from said first mid second hand-held devices.

9. The computer-implemented system as set forth claim 1, wherein said short messages include payment information.

10. The computer-implemented system as set forth in claim 9, wherein said payment information is calculated based on included hours of operation.
